(19) United States
(12) Patent Application Publication
(10) Pub. No.: US 2015/0244583 A1
(43) Pub. Date: Aug. 27, 2015

(54) System and Method for Creating Service Chains and Virtual Networks in the Cloud

(71) Applicant: FutureWei Technologies, Inc., Plano, TX (US)

(72) Inventors: Tao Wan, Ottawa (CA); Guoli Yin, Ottawa (CA); Yapeng Wu, Nepean (CA); Peter Ashwood-Smith, Gatineau (CA); Xingjun Chu, Ottawa (CA)

(73) Assignee: FUTUREWEI TECHNOLOGIES, INC., Plano, TX (US)

(21) Appl. No.: 14/191,526

(22) Filed: Feb. 27, 2014

(51) Int. Cl. H04L 12/24; H04L 29/08

(52) U.S. Cl. CPC H04L 41/145; H04L 41/22; H04L 67/02

(57) ABSTRACT

Embodiments are provided herein for creating virtual networks with service chains, such as n-tier networks, in the cloud. In an embodiment, a network diagram for a virtual network is received from a user via a graphical user interface. The network diagram comprises elements that represent virtual or physical network components. The network components include switches, routers, firewalls, links, service appliances, virtual machines, servers, or other network components. Upon successfully validating the network diagram, via a validation step, the network diagram is compiled into application programming interface (API) calls ready for execution. The executed APIs are used to establish the virtual network on a physical network infrastructure. The virtual network comprises virtual network components corresponding to the elements or the network diagram.

### TECHNICAL FIELD

The present invention relates to the field of cloud computing, and, in particular embodiments, to a system and method for creating service chains and virtual networks in the cloud.

### BACKGROUND

Typical cloud networks for cloud applications and services usually consist of multiple tiers, referred to as n-tiers. Each tier hosts computers or processors that run specific functions. In addition, network tiers are usually separated from each other by network components such as firewalls and load balancers among others. An example of n-tier networks is a 3-tier network that includes a web tier, an application tier, and a database tier, coupled in sequence to a public network, e.g., the Internet. Each of the tiers resides behind a firewall which protects one tier from another. Typically, n-tier cloud networks and services are created using, command lines, preconfigured input forms, or combinations of both. Web services such as Amazon EC2™ (Elastic Compute Cloud) and OpenStack™ are examples of such approaches to build n-tier cloud networks for cloud applications and services. These web services are available for customers to build their own cloud networks and services. This includes creating security groups (SGs), each comprising a set of access control lists (ACLs). The created SGs can be applied to virtual machines (VMs) at the physical network to virtualize n-tier networks. Using such web services and similar command line and form input formats to create n-tier cloud networks and services can be challenging and time/cost demanding. There is a need for a simpler system and method for creating n-tier or virtual cloud networks and service chains, which can resolve such issues.

### SUMMARY OF THE INVENTION

In accordance with an embodiment of the disclosure, a method by a cloud processing component for creating virtual networks includes receiving, from a user via a graphical user interface, a network diagram for a virtual network. The network diagram comprises elements, each one of the elements representing a network component. The method further includes validating the network diagram, and upon successful validation of the network diagram, compiling the network diagram into application programming interface (API) calls. The API calls are then executed. Using the executed the API calls, the virtual network is established according to the network diagram. The virtual network comprises virtual network components corresponding to the elements of the network diagram.

In accordance with another embodiment of the disclosure, a method by a user for creating virtual networks includes entering, using a graphical user interface of a cloud computing platform, a network diagram representing a virtual network. The network diagram comprises elements, each one of the elements representing a network component. The network diagram enables the cloud computing platform to establish, using application programming interface (API) calls, the virtual network. The virtual network comprises virtual network components corresponding to the elements of the network diagram.

In accordance with yet another embodiment of the disclosure, a network component for creating virtual networks includes at least one processor and a non-transitory computer readable storage medium storing programming for execution by the at least one processor. The programming includes instructions to receive, from a user via a graphical user interface, a network diagram for a virtual network. The network diagram comprises elements, each one of the elements representing a physical network component. The programming includes further instructions to validate the network diagram, and upon successful validation of the network diagram, compile the network diagram into API calls. The network component is further configured to execute the API calls, and establish, using the executed the API calls, the virtual network according to the network diagram. The virtual network comprises virtual network components corresponding to the elements or the network diagram.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example of a 3-tier cloud network;

FIG. 2 illustrates an embodiment for creating n-tier networks with service chains in the cloud;

FIG. 3 illustrates an embodiment of creating n-tier networks via a graphical user interface;

FIG. 4 illustrates an embodiment of a method for creating n-tier networks; and

FIG. 5 is a diagram of a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

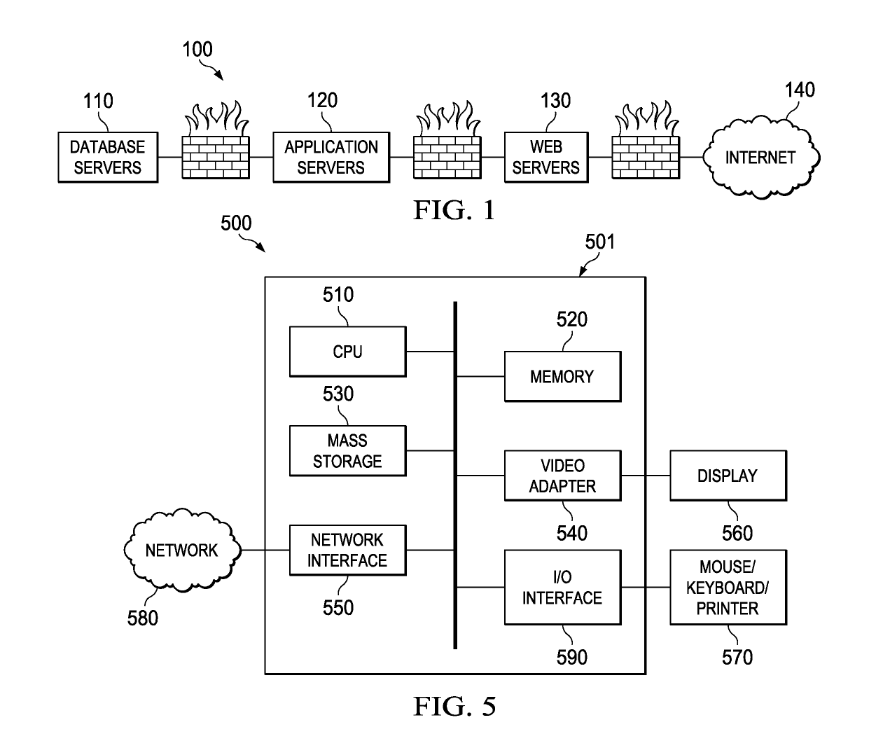

FIG. 1 shows an example of a 3-tier network 100 that includes a web tier 110, an application tier 120, and a database tier 130. The tiers face a public network 140, for example the Internet. Each tier hosts computers, processors, or servers that run specific functions of the corresponding tier. Each tier also resides behind a firewall component or function that protects the corresponding tier from external components (other tiers and the public network). Typically, software tools such as Microsoft Visio™, or network planning tools such as OpNET™ can be used to draw a network diagram of the 3-tier or other n-tier networks. The diagram is used as a guideline by the user (e.g., a system engineer) to select and connect suitable network equipment and servers for establishing the n-tier network. Typically, to build n-tier virtual networks in the cloud, element groups, such as security groups (SGs) by Amazon, are created using a software tool, such as EC2™. Policy rules are then added, e.g., via access control lists (ACLs) for the traffic of each SG. For example, for a 2-tier network, two SGs, WebServerSG and DBServerSG, are created. ACLs are then added for both inbound and outbound traffic for each SG. Virtual machines (VMs) are then established for each tier, and used to apply the SGs.

With the rapid adoption of cloud computing, customers need to be able to conveniently construct n-tier networks in the cloud to migrate or mimic their on-premise environment. However, current cloud computing platforms such as Amazon EC2™ and OpenStack™ include limited user interfaces for creating virtual networks, such as using input forms and line commands. Embodiments are provided herein for creating service chains and virtual networks, such as n-tier networks, in the cloud. The embodiments include systems and methods for building virtual networks in the cloud using user-friendly network diagram drawing methodology and user interface. Using the schemes herein, a cloud computing provider can provide a user-friendly self-service that allows its customers to easily create virtual networks in the cloud, which mimic their existing on-premise physical networks.

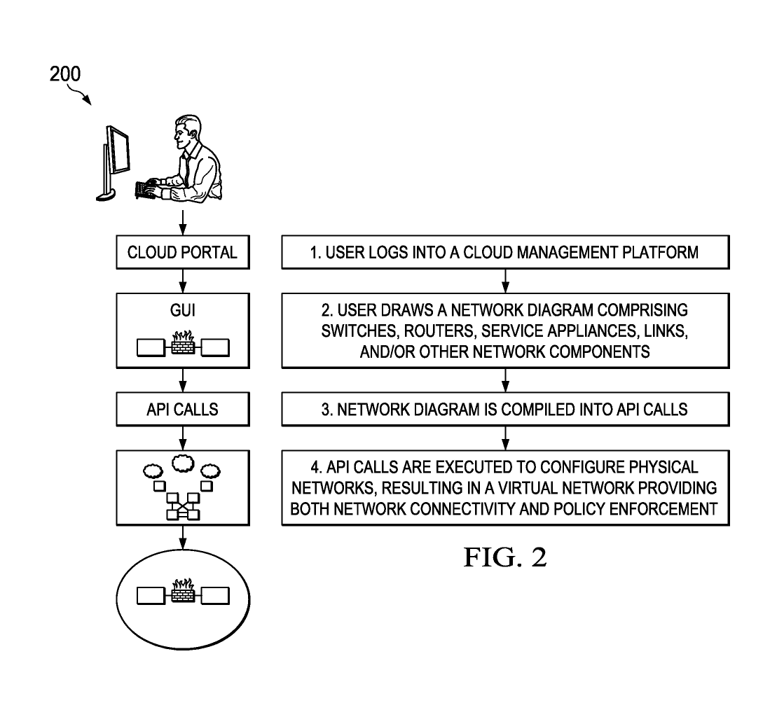

FIG. 2 shows an embodiment scheme 200 for creating virtual networks, such as n-tier networks with service chains in the cloud. A user can first log into a cloud management platform/system via a cloud portal, e.g., a web site or service. The user then draws a network diagram representing the n-tier network. Each of the tiers provides a service. In this scenario, 3 services, including a database service, an application service, and a web service, are linked in that sequence, hence forming a service chain. The network diagram can include any suitable network components that mimic or correspond to network components, such as switches, routers, other service appliances, links, and/or other network components. The network diagram also reflects the actual intended topology of the virtual network, such as the hierarchy/sequence and interconnections between the different components. The process of drawing a network diagram is interactive in that the system may ask the user for input and also provide feedback according to user's actions.

The network diagram is drawn using a graphical user interface (GUI) that is part of the cloud management platform/system. The GUI can be provided by a software tool or web service. After submitting the network diagram which represents the n-tier network, the system can validate the network diagram. If the network diagram passes the validation process, the system compiles the network diagram into application programming interface (API) calls. The API calls are then executed by the system to configure one or more underlying physical networks to establish a virtual n-tier network according to the network diagram of the user. Thus, the diagram components are mapped, essentially one-to-one, into corresponding virtual network components. The system is aware of each of the components or elements of the diagram and is capable to map the element to a corresponding virtual element. The virtual network provides network connectivity and also guarantees policy enforcement. The virtual network can be established according to the available virtualization technology provided by the system or the physical networks, such as a virtual local area network (VLAN).

In an embodiment, each user or a group of users (e.g., in an enterprise) initially get (e.g., via purchase) or is initially assigned a resource pool comprising a maximum quantity of available resources for the user or group to establish virtual or cloud based n-tier networks. For example, the resource pool can include a maximum number of VLANs, switch ports, forwarding entries, bandwidth, storage size, and/or other network resources which are available to the user or group. The total available resources in a resource pool assigned to a user or a group of users can also be divided (reassigned) to other individual users or groups. Accordingly, each user or group uses the corresponding designated resources for building corresponding virtual n-tier networks.

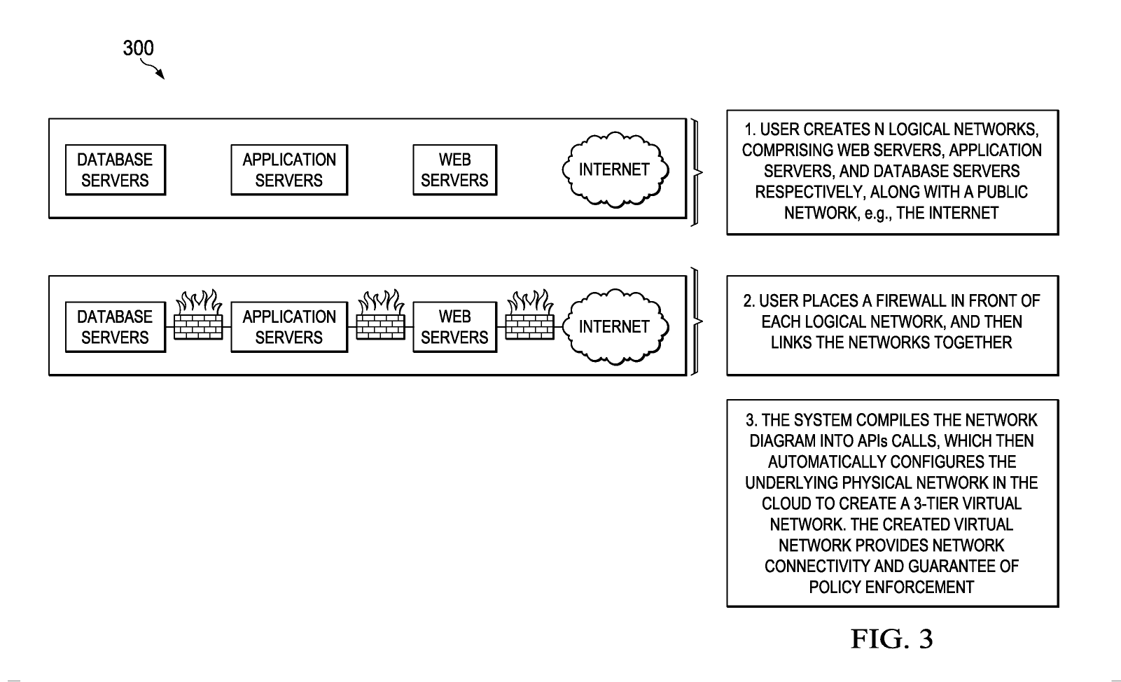

FIG. 3 shows an embodiment scheme 300 of creating virtual networks, such as n-tier networks, via a graphical user interface. As described above, the graphical interface is presented to the user (after signing in) by a cloud system. As an example, the user creates 3 logical networks (a 3-tier virtual network), comprising web servers, application servers, and database servers that connected in sequence to the Internet (or a public network) in that order. The 3 tiers or logical networks are created by drawing a corresponding diagram with a box or element for each component, as shown in FIG. 3. The elements also include firewalls between the logical networks and links between the elements, as placed by the user. This completes the network diagram. The user can then submit the diagram to the system to build his n-tier network in the cloud. The cloud system then compiles the network diagram into API calls and executes the API calls automatically. The automatically executed API calls configure the underlying physical network(s) to create a 3-tier virtual network. The created virtual network provides network connectivity and guarantee policy enforcement.

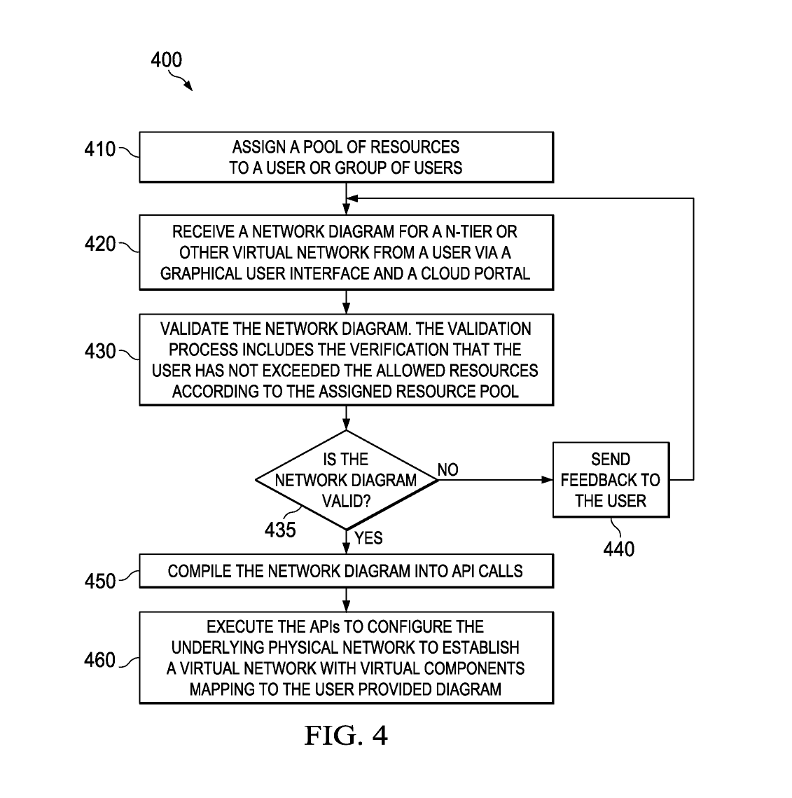

FIG. 4 illustrates an embodiment of a method 400 for creating virtual networks, such as n-tier networks. At step 410, a pool of resources is assigned to a user or group of users. At step 420, a network diagram of a n-tier or other virtual network is received from a user via a graphical user interface and a cloud portal. At step 430, the system validates the network diagram. The validation process includes the verification that the user has not exceeded the allowed resources according to the assigned resource pool. Other validation rules may apply, such as network policy rules. At decision step 435, the system checks whether the network diagram is valid. If the network diagram is valid, then the method 400 proceeds to step 450. Otherwise, at step 440, a feedback is sent to the user to correct the network diagram. The method 200 then returns to step 430 to wait for user input. Alternatively, at step 450, the network diagram is compiled into API calls. At step 460, the APIs are executed to configure the underlying physical network to establish a virtual network with (virtual) components that map the elements of the user network diagram.

FIG. 5 is a block diagram of an exemplary processing system 500 that can be used to implement various embodiments. The processing system is part of a cloud platform/system for creating n-tier networks with service chains in the cloud as described above. The processing system 500 may comprise a processing unit 501 equipped with one or more input/output devices, such as a speaker, microphone, mouse, touchscreen, keypad, keyboard, printer, display, and the like. The processing unit 501 may include a central processing unit (CPU) 510, a memory 520, a mass storage device 530, a video adapter 540, and an Input/Output (I/O) interface 590 connected to a bus. The bus may be one or more of any type of several bus architectures including a memory bus or memory controller, a peripheral bus, a video bus, or the like.

The CPU 510 may comprise any type of electronic data processor. The memory 520 may comprise any type of system memory such as static random access memory (SRAM), dynamic random access memory (DRAM), synchronous DRAM (SDRAM), read-only memory (ROM), a combination thereof, or the like. In an embodiment, the memory 520 may include ROM for use at boot-up, and DRAM for program and data storage for use while executing programs. The mass storage device 530 may comprise any type of storage device configured to store data, programs, and other information and to make the data, programs, and other information accessible via the bus. The mass storage device 530 may comprise, for example, one or more of a solid state drive, hard disk drive, a magnetic disk drive, an optical disk drive, or the like.

The video adapter 540 and the I/O interface 590 provide interfaces to couple external input and output devices to the processing unit. As illustrated, examples of input and output devices include a display 560 coupled to the video adapter 540 and any combination of mouse/keyboard/printer 570 coupled to the I/O interface 590. Other devices may be coupled to the processing unit 501, and additional or fewer interface cards may be utilized. For example, a serial interface card (not shown) may be used to provide a serial interface for a printer.

The processing unit 501 also includes one or more network interfaces 550, which may comprise wired links, such as an Ethernet cable or the like, and/or wireless links to access nodes or one or more networks 580. The network interface 550 allows the processing unit 501 to communicate with remote units via the networks 580. For example, the network interface 550 may provide wireless communication via one or more transmitters/transmit antennas and one or more receivers/receive antennas. In an embodiment, the processing unit 501 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method by a cloud processing component for creating virtual networks, the method comprising:
receiving, from a user via a graphical user interface, a network diagram for a virtual network, wherein the network diagram comprises elements, each one of the elements representing a network component;
validating the network diagram;
upon successful validation of the network diagram, compiling the network diagram into application programming interface (API) calls;
executing the API calls; and
establishing, using the executed the API calls, the virtual network according to the network diagram, wherein the virtual network comprises virtual network components corresponding to the elements or the network diagram.

2. The method of claim 1 further comprising assigning a pool of resources to the user, wherein validating the network diagram includes verifying that the network diagram does not use more resources than is assigned in the resource pool for the user.

3. The method of claim 1, wherein receiving the network diagram via the graphical user interface includes providing feedback to the user according to actions of the user.

4. The method of claim 1 further comprising upon unsuccessful validation of the network diagram, providing feedback to the user indicating missing or incorrect input in the network diagram.

5. The method of claim 1, wherein establishing the virtual network includes mapping each one of the elements of the network diagram to one corresponding component of the virtual network components in accordance with a topology of the network diagram.

6. The method of claim 1, wherein establishing the virtual network using the executed the API calls includes providing network connectivity and policy enforcement.

7. The method of claim 1, wherein the virtual network is a virtual local area network (VLAN).

8. The method of claim 1, wherein the virtual network includes a sequence of network tiers, and wherein the elements of the network diagram include blocks representing virtual machines (VMs) or servers for each one of the tier networks, and firewalls that separate the network tiers.

9. The method of claim 1, wherein the network component represented by each one of the elements of the network diagram is a switch, a router, a firewall, a link, or a service appliance.

10. A method by a user for creating virtual networks, the method comprising:
entering, using a graphical user interface of a cloud computing platform, a network diagram representing a virtual network, the network diagram comprising elements, each one of the elements representing a network component,
wherein the network diagram enables the cloud computing platform to establish, using application programming interface (API) calls, the virtual network, and
wherein the virtual network comprises virtual network components corresponding to the elements of the network diagram.

11. The method of claim 10, wherein the virtual network includes a sequence of network tiers, and wherein the elements of the network diagram include blocks representing virtual machines (VMs) or servers for each one of the tier networks, and firewalls that separate the network tiers.

12. The method of claim 10 further comprising accessing the graphical user interface via a web portal.

13. The method of claim 10 further comprising selecting the elements of the network diagram in accordance with a pool of resources assigned to the user.

14. The method of claim 10, wherein entering the network diagram using the graphical user interface includes receiving feedback from the cloud computing platform according to actions of the user.

15. A network component for creating virtual networks, the network component comprising:
at least one processor; and
a non-transitory computer readable storage medium storing programming for execution by the at least one processor, the programming including instructions to:
receive, from a user via a graphical user interface, a network diagram for a virtual network, wherein the network diagram comprises elements, each one of the elements representing a physical network component;
validate the network diagram;
upon successful validation of the network diagram, compile the network diagram into application programming interface (API) calls;
execute the API calls; and
establish, using the executed the API calls, the virtual network according to the network diagram, wherein the virtual network comprises virtual network components corresponding to the elements or the network diagram.

16. The network component of claim 15, wherein the programming includes further instructions to assign a pool of resources to the user, wherein validating the network diagram includes verifying that the network diagram does not use more resources than is assigned in the resource pool for the user.

17. The network component of claim 15, wherein the instructions to establish the virtual network include instructions to map each one of the elements of the network diagram to one corresponding component of the virtual network components in accordance with a topology of the network diagram.

18. The network component of claim 15, wherein the instructions to establish the virtual virtual network using the executed the API calls include instructions to provide network connectivity and policy enforcement.

19. The network component of claim 15, wherein the virtual network includes a database tier, an application tier, and a web tier inter-coupled in sequence via links, wherein the web tier is further coupled to a public network, and wherein the virtual network further includes a firewall on each of the links between the database tier, the application tiers, and the web tier.

20. The network component of claim 15, wherein the graphical user interface is accessible via a web portal.
